(19) United States
(12) Patent Application Publication
(10) Pub. No.: US 2026/0239452 A1
(43) Pub. Date: Aug. 13, 2026

(54) Supporting Multiple Timing Advances for Multiple Transmission and Reception Points

(71) Applicant: Apple Inc., Cupertino, CA (US)

(72) Inventors: Hong HE, San Jose, CA (US); Chunxuan YE, San Diego, CA (US); Dawei ZHANG, Saratoga, CA (US); Jie CUI, San Jose, CA (US); Oghenekome OTERI, San Diego, CA (US); Wei ZENG, Saratoga, CA (US)

(21) Appl. No.: 19/154,216

(22) PCT Filed: Jan. 24, 2024
(86) PCT No.: PCT/US2024/012680

§ 371 Date: Aug. 6, 2025

Related U.S. Application Data
(60) Provisional application No. 63/484,014, filed on Feb. 9, 2023.

(51) Int. Cl. H04W 74/0838; H04W 56/00; H04W 74/00; H04W 76/20

(52) U.S. Cl. CPC H04W 74/0838; H04W 56/0045; H04W 74/006; H04W 76/20

(57) ABSTRACT

An apparatus configured to receive Downlink Control Information (DCI) on a Physical Downlink Control Channel (PDCCH) with a PDCCH order that initiates a Contention Free Random Access (CFRA) procedure comprising a Physical Random Access Channel (PRACH) transmission, wherein the DCI comprises an identification of a first transmission and reception point (TRP) or a second TRP to which the PRACH transmission is to be directed and configure transceiver circuitry to transmit the PRACH transmission to the first TRP or second TRP based on at least in part the DCI.

### BACKGROUND

A user equipment (UE) may connect to a network via a base station. The base station may control multiple transmission and reception points (TRPs). In New Radio, it has been decided that for multi-Downlink Control Information (multi-DCI) based multi-TRP operation with two timing advance (TA) enhancements, Contention Free Random Access (CFRA) triggered by Physical Downlink Control Channel (PDCCH) order for both intra-cell and inter-cell cases should be supported. However, it needs to be determined how to enhance the PDCCH order CFRA procedure such that the Physical Random Access Channel (PRACH) is triggered towards a second TRP.

### SUMMARY

Some example embodiments are related to an apparatus having processing circuitry configured to receive Downlink Control Information (DCI) on a Physical Downlink Control Channel (PDCCH) with a PDCCH order that initiates a Contention Free Random Access (CFRA) procedure comprising a Physical Random Access Channel (PRACH) transmission, wherein the DCI comprises an identification of a first transmission and reception point (TRP) or a second TRP to which the PRACH transmission is to be directed and configure transceiver circuitry to transmit the PRACH transmission to the first TRP or second TRP based on at least in part the DCI.

Other example embodiments are related to a method for receiving Downlink Control Information (DCI) on a Physical Downlink Control Channel (PDCCH) with a PDCCH order that initiates a Contention Free Random Access (CFRA) procedure comprising a Physical Random Access Channel (PRACH) transmission, wherein the DCI comprises an identification of a first transmission and reception point (TRP) or a second TRP to which the PRACH transmission is to be directed and configuring the PRACH transmission to the first TRP or second TRP based on at least in part the DCI.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example base station according to various example embodiments.

FIG. 4 shows an example arrangement comprising two TRPs transmitting to a UE according to various example embodiments.

FIG. 5 shows an example DCI format including a new target cell index field according to various example embodiments.

FIG. 6 shows a Random Access Response (RAR) Medium Access Control (MAC) Protocol Data Unit (PDU) including a repurposed reserved bit to indicate a Timing Advance Group Identity (TAG-ID) according to various example embodiments.

FIG. 7 shows a diagram of RACH preambles illustrating the CFRA PRACH resources associated with a given Synchronization Signal Block (SSB) being divided into two sub-groups according to various example embodiments.

FIG. 8 shows a diagram of SSBs of a serving cell being divided into two sub-groups according to various example embodiments.

FIG. 9 shows a signaling diagram illustrating a first example of UL beam determination for PDCCH-Ordered PRACH transmissions according to various example embodiments.

FIG. 10 shows a signaling diagram illustrating a second example of UL beam determination for PDCCH-Ordered PRACH transmissions according to various example embodiments.

FIG. 11 shows an example timing diagram illustrating an example RAR window according to various example embodiments.

FIG. 12 provides an example timing diagram for determining the DL reference timing based on the DL-RSs associated with the different CORESET Pool Index value for a first TRP and a second TRP according to various example embodiments.

### DETAILED DESCRIPTION

The example embodiments may be further understood with reference to the following description and the related appended drawings, wherein like elements are provided with the same reference numerals. The example embodiments relate to multi-DCI based multi-TRP operation with two TA enhancements to support a case where a PDCCH order sent by one TRP triggers a RACH procedure towards either the same TRP or a different TRP at least for inter-cell multi-DCI.

The example embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any electronic component.

The example embodiments are also described with regard to a fifth generation (5G) New Radio (NR) network and a next generation node B (gNB). However, reference to a 5G NR network or a gNB is merely provided for illustrative purposes. The example embodiments may be utilized with any appropriate type of network and base station.

The gNB may be configured with multiple transmission and reception points (TRPs). Throughout this description, a TRP generally refers to a set of components configured to transmit and/or receive a beam. In some embodiments, multiple TRPs may be deployed locally at the gNB. For example, the gNB may include multiple antenna arrays/panels that are each configured to generate a different beam. In other embodiments, multiple TRPs may be deployed at various different locations and connected to the gNB via a backhaul connection. For example, multiple small cells may be deployed at different locations and connected to the gNB. However, these examples are merely provided for illustrative purposes. Those skilled in the art will understand that TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam.

The network may support multi-TRP (mTRP) based transmission. From the perspective of the UE, mTRP operation may include establishing and maintaining a connection with multiple TRPs at the same time. To receive the mTRP transmissions, the UE may be equipped with multiple reception (RX) panels (e.g., antenna panels and receive chains), wherein each RX panel may receive a signal from an individual TRP.

According to the example embodiments, techniques are introduced that enable multi-DCI based multi-TRP operation including, but not limited to, differentiating the intra-cell and inter-cell CFRA procedure, determining the uplink (UL) beam for the PDCCH-ordered preamble transmission towards to the second TRP, determining the beam information to receive a Random Access Response (RAR), including Type-1 Common Search Space (CSS) monitoring and Physical Downlink Shared Channel (PDSCH) reception and transmitting a Timing Advance Group Identity (TAG-ID) to the TRPs.

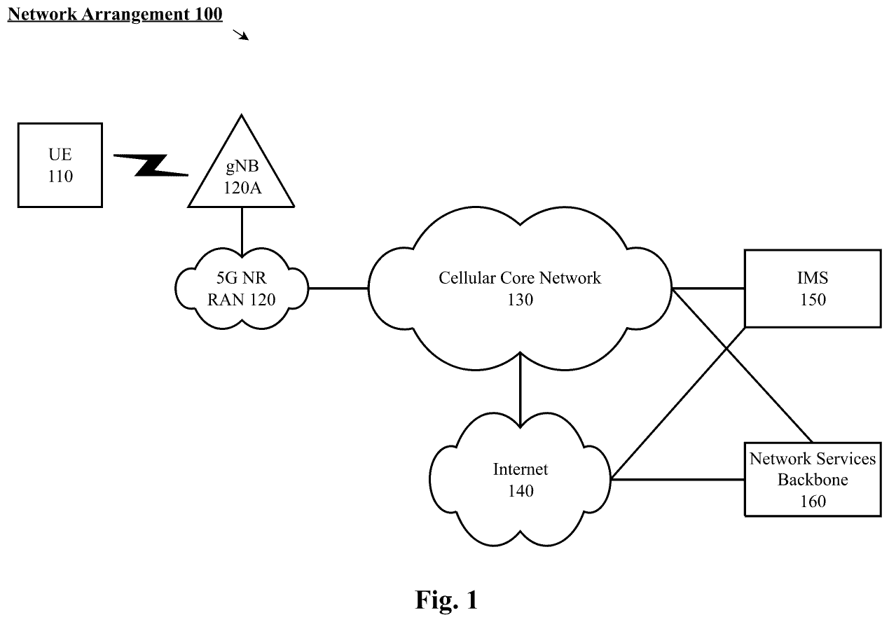

FIG. 1 shows an example network arrangement 100 according to various example embodiments. The example network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IOT) devices, etc. An actual network arrangement may include any number of UEs being used by any number of users. Thus, the example of a single UE 110 is merely provided for illustrative purposes.

The UE 110 may be configured to communicate with one or more networks. In the example of the network arrangement 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the example embodiments, the UE 110 may establish a connection with the 5G NR RAN 120. Therefore, the UE 110 may have at least a 5G NR chipset to communicate with the 5G NR RAN 120.

The 5G NR RAN 120 may be a portion of a cellular network that may be deployed by a network carrier (e. g., Verizon, AT&T, T-Mobile, etc.) . The 5G NR RAN 120 may include, for example, base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In the network arrangement 100, the 5G NR RAN 120 deploys a gNB 120A. The gNB 120A may be configured with multiple TRPs. Each TRP may represent one or more components configured to transmit and/or receive a signal. In some embodiments, multiple TRPs may be deployed locally at the gNB 120A. In other embodiments, multiple TRPs may be distributed at different locations and connected to the gNB 120A via a backhaul connection. For example, multiple small cells may be deployed at different locations and connected to the gNB 120A. However, these examples are merely provided for illustrative purposes.

TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam. As indicated above, in some examples, the terms “TRP” and “cell” may be used interchangeably to generally refer to the same connection and/or node.

Any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

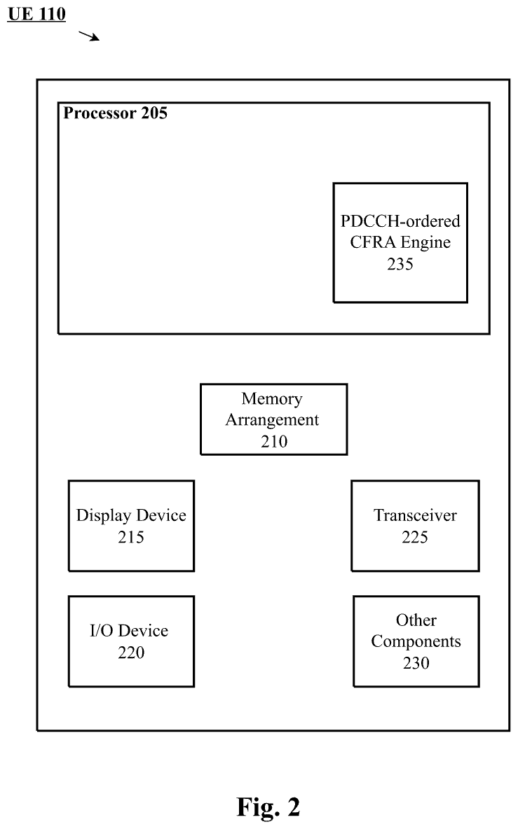

FIG. 2 shows an example UE 110 according to various example embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a PDCCH-ordered CFRA engine 235. The PDCCH-ordered CFRA engine 235 may perform various operations related to multi-DCI based multi-TRP operation. These various operations will be described in greater detail below.

The above referenced engine 235 being applications (e. g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

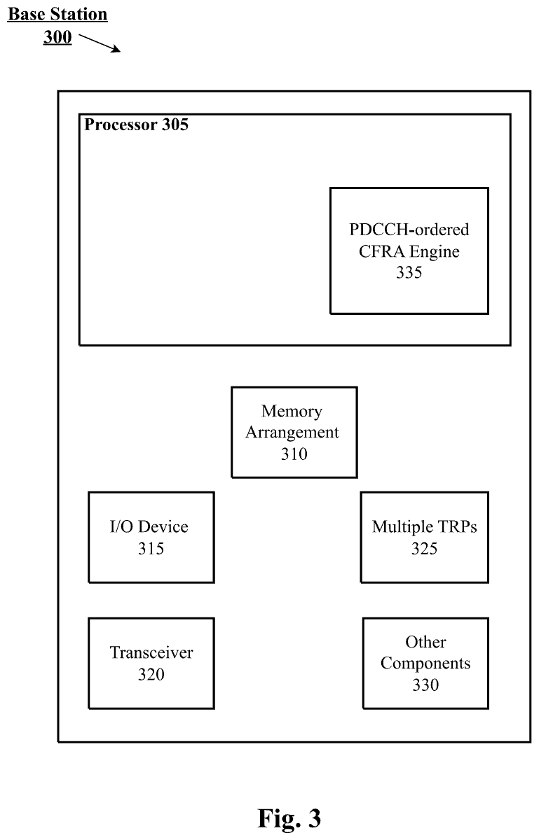

FIG. 3 shows an example base station 300 according to various example embodiments. The base station 300 may represent the gNB 120A or any other type of access node through which the UE 110 may establish a connection and manage network operations.

The base station 300 may include a processor 305, a memory arrangement 310, an input/output (I/O) device 315, a transceiver 320, multiple TRPs 325 and other components 330. The other components 3330 may include, for example, an audio input device, an audio output device, a battery, a data acquisition device, ports to electrically connect the base station 300 to other electronic devices and/or power sources, TxRUS, transceiver chains, antenna elements, antenna panels, etc.

As indicated above, in some scenarios, the multiple TRPs 325 may be deployed locally at the base station 300. In other scenarios, one or more of the multiple TRPs may be deployed at physical locations remote from the base station 300 and connected to the base station via a backhaul connection. The base station 300 may be configured to control the multiple TRPs 325 and perform operations such as, but not limited to, assigning resources, configuring reference signals, implementing beam management techniques, etc.

The processor 305 may be configured to execute a plurality of engines for the base station 300. For example, the engines may include a PDCCH-ordered CFRA engine 335 that may perform various operations related to multi-DCI based multi-TRP operation. These operations will be described in greater detail below.

The above noted engine 335 being an application (e.g., a program) executed by the processor 305 is only example. The functionality associated with the engine 335 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The example embodiments may be implemented in any of these or other configurations of a base station.

The memory arrangement 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

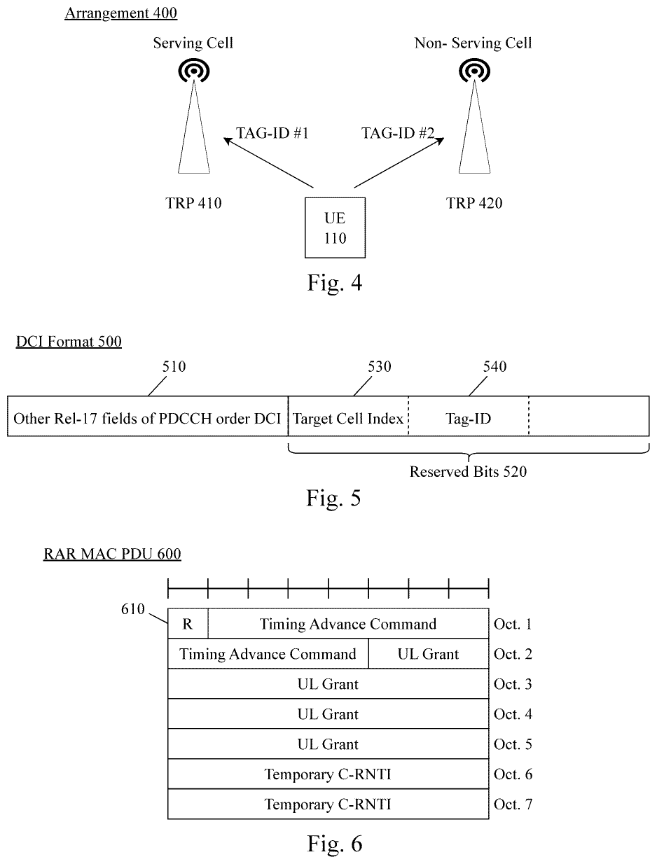

FIG. 4 shows an example arrangement 400 comprising two TRPs 410 and 420 transmitting to a UE 110 according to various example embodiments. FIG. 4 illustrates an example where the UE 110 has activated two panels and is exchanging signals with a first TRP 410 via a first panel and is exchanging signals with a second TRP 420 via a second panel. In this example, it may be considered that the TRP 410 is the serving cell and the TRP 420 is a non-serving cell.

As described above, in NR it has been decided that for multi-DCI based multi-TRP operation with two TA enhancements, CFRA triggered by PDCCH order for both intra-cell and inter-cell cases should be supported. The example embodiments provide enhancements to the PDCCH order CFRA procedure such that the PRACH may be triggered towards a second TRP (e.g., the TRP that did not transmit the DCI). These enhancements of the example embodiments address issues associated with multi-DCI based multi-TRP operation including, but not limited to, differentiating the intra-cell and inter-cell CFRA procedure, determining the uplink (UL) beam for the PDCCH-ordered preamble transmission towards to the second TRP determining the beam information to receive a Random Access Response (RAR), including Type-1 Common Search Space (CSS) monitoring and Physical Downlink Shared Channel (PDSCH) reception.

In addition, as shown in FIG. 4, the UE 110 will transmit a Timing Advance Group Identity (TAG-ID) to the TRPs.

The example embodiments provide manners of indicating the TAG-ID associated with two TRPs. These example embodiments address issues such as determining the exact downlink (DL) reference timing on a per mTRP basis.

In some example embodiments, a 3-bit target cell index field may be introduced for the legacy PDCCH order DCI format by repurposing the reserved bits for fallback DCI format 1_0 or adding a new field for DCI format 1_1. In some designs, an additional PCI index associated with the non-serving cell (e. g., TRP 420) by Radio Resource control (RRC) signaling may be indicated by the new field. The value of codepoint ‘000’ may be reserved for an intra-cell PDCCH order RACH procedure.

FIG. 5 shows an example DCI format 500 including a new target cell index field according to various example embodiments. The example of FIG. 5 shows a fallback DCI format 1_0 with the new target cell index field. However, based on the principles described herein, those skilled in the art will understand how to modify other existing DCI formats to include the new target cell index field.

The DCI format 500 includes the legacy other Rel-17 fields related to PDCCH order for DCI 510. The DCI format 500 also shows the current reserved bits 520. The reserved bits 520 are used to introduce the new target cell index field 530. As described above, the new target cell index field 530 may be a 3-bit field to indicate the target cell. However, the new target cell index field 530 is not limited to 3-bits and may be another size based on a number of potential target cells. As described above, the UE 110 may have received RRC signaling that included a PCI index associated with the non-serving cell (e.g., TRP 420). If the non-serving cell is the target cell, this PCI index may be indicated by the new target cell index field 530. As also described above, the value ‘000’ in the new target cell index field 530 may be reserved for an intra-cell PDCCH order RACH procedure.

The DCI format 500 with the new target cell index field 530 remains the same size as the legacy (e.g., Rel-17 DCI) because some of the available reserved bits 520 are repurposed to implement the new target cell index field 530.

As described above, the example embodiments also introduce manners of indicating the TAG-ID associated with two TRPs. The example of FIG. 5 shows one manner of indicating the TAG-ID corresponding to the identified target cell (e.g., by the target cell index field 530). In this example embodiment, the DCI format 500 also includes a further 3-bit field (TAG-ID field 540) that also comprises repurposed reserved bits 520. The value of the TAG-ID corresponding to the identified target cell is one from up to 8 TAG candidates (e.g., 3-bit combinations).

Again, the DCI format 500 with the TAG-ID field 540 remains the same size as the legacy (e.g., Rel-17 DCI) because some of the available reserved bits 520 are repurposed to implement the TAG-ID field 540. The DCI format 500 may not include the TAG-ID field 540 because, as will be described below in greater detail, there may be other manners of indicating the TAG-ID.

In other example embodiments, the associated TAG-ID is provided by legacy RAR Medium Access Control (MAC) Protocol Data Unit (PDU) by repurposing one reserved bit.

FIG. 6 shows a RAR MAC PDU 600 including a repurposed reserved bit to indicate a TAG-ID according to various example embodiments. In the example of FIG. 6, it may be considered that the reserved bit 610 may be repurposed to indicate the TAG-ID corresponding to the target cell. A 1-bit field may only carry values “0” or “1” and thus, the exact TAG-ID cannot be directly indicated in the reserved bit 610. Rather, the TAG-ID may be inferred from the value of the reserved bit 610 and the context of the transmission. The following provides examples of the how the TAG-ID may be inferred.

In these example embodiments, it may be considered that the TAG-ID for the second TRP is either preconfigured or implicitly determined based on the TAG-ID of first TRP. Then, the 1-bit repurposed reserved bit 610 with a value of ‘0’ indicates the TA is applied for the TAG-ID associated with first TRP and a value of ‘1’: indicates the TA is applied for the TAG-ID associated with the second TRP.

According to these example embodiments, the TAG-ID may be associated with different UL signals/channels. The UE 110 may be provided with a coresetPoolIndex value of ‘0’ or ‘1’ for each TAG-ID by RRC signaling. Thus, in one example, for a Physical Uplink Shared Channel (PUSCH) transmission that is scheduled by Dynamic Grant-PUSCH (DG-PUSCH) or activated by a DCI (e.g., Type-2 Configured Grant-PUSCH (CG-PUSCH) ) associated with a CORESET with CORESETpoolIndex value i, (i=0,1) the TAG-ID associated with the CORESETpoolIndex value value i is applied for the PUSCH transmission, e.g., the value of i is the value included in the reserved bit 610. Depending on the value in the reserved bit 610, the TAG-ID will correspond to the TAG-ID of the TRP having the corresponding CORESETpoolIndex value.

In another example, for Type-1 CG-PUSCH, Sounding Reference Signal (SRS) transmissions (including P/SP/AP SRS) and Physical Uplink Control Channel (PUCCH) resources, the TAG-ID is provided through RRC signaling as part of the configuration.

In further example embodiments, the associated TAG-ID is provided for intra-cell mTRP operation. For example, the CFRA PRACH resources associated with a given SSB may be divided into two sub-groups. If the corresponding preamble belongs to the n-th group (n=1, 2), then the TA obtained via the RACH procedure corresponds to the n-th TAG.

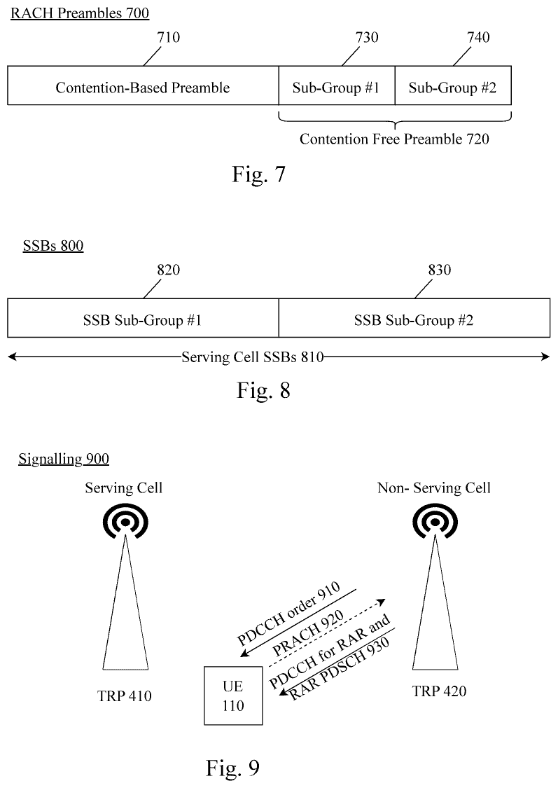

FIG. 7 shows a diagram of RACH preambles 700 illustrating the CFRA PRACH resources associated with a given SSB being divided into two sub-groups according to various example embodiments. As shown in the example, there is a Contention-Based Preamble 710 that can be ignored for the purposes of these example embodiments. There is also a Contention-Free Preamble 720. As described above, the Contention-Free Preamble 720 is divided into two sub-groups, Sub-Group #1 730 and Sub-Group #2 740. The RACH resources are provided by the PDCCH order. Thus, the UE 110 can derive the TAG-ID based on which sub-group triggered the RACH procedure.

In the example embodiments, the sub-group with lower ID (e. g., Sub-Group #1 730) may. be associated with the TAG-ID with a lower ID. However, this is not a requirement of the example embodiments, any other association between the sub-groups and the TAG-ID may be used.

In still further example embodiments, the associated TAG-ID is also provided for intra-cell mTRP operation. In these example embodiments, the SSBs are again divided into two sub-groups but by System Information Block (SIB) information or RRC signaling. If the corresponding SSB indicated in the PDCCH order DCI belongs to the n-th group (n=1, 2), then the TA obtained via the RACH procedure corresponds to the n-th TAG-ID.

FIG. 8 shows a diagram of SSBs 800 of a serving cell being divided into two sub-groups according to various example embodiments. In this example, the serving cell SSBs 810 are divided into SSB Sub-Group #1 820 and SSB Sub-Group #1 830. As described above, this division may be signaled via SIB or RRC signaling. When the PDCCH order DCI indicates an SSB that belongs to one of the groups, the RACH procedure corresponds to the TAG-ID associated with the group.

As described above, the example embodiments are also related to UL Beam determination for PDCCH-Ordered PRACH transmissions. As will be described in greater detail below, in some example embodiments, the PRACH transmissions are aligned with the TRP transmitting the PDCCH order while in other example embodiments the PRACH transmissions are not aligned with the TRP transmitting the PDCCH order. These example embodiments are described in more detail below.

According to some example embodiments, the UE 110 uses the reference signals (RSs) (e.g., SSB or Channel State Information (CSI)-RS associated with the serving cell) configured with Quasi Co-Location (QCL) Type-D for the PDCCH where the PDCCH order triggering CFRA is detected for UL beam determination. These example embodiments may be appropriate for handover but may also be applied to other scenarios.

FIG. 9 shows a signaling diagram 900 illustrating a first example of UL beam determination for PDCCH-Ordered PRACH transmissions according to various example embodiments. The signaling diagram 900 illustrates the example described directly above. As will be described in greater detail below, in FIG. 9 the TRP 420 transmitting the PDCCH order is also the TRP to which the PRACH is directed.

In 910, the PDCCH order is transmitted to the UE 110 from the non-serving cell TRP 420. This PDCCH order transmitted from the CORESET associated with target TRP/non-serving cell 420 (i.e., CORESETpoolIndex=1) by the non-serving cell TRP 420 may still trigger the PRACH toward the non-serving cell TRP 420.

Thus, the CORESET identified in the PDCCH order allows the UE 110 to select the appropriate TRP and beam for PRACH transmissions. Thus, in 920, the UE 110 transmits a PRACH to the non-serving cell TRP 420 and in 930 the non-serving cell TRP 420 transmits a PDCCH for RAR and a RAR PDSCH to the UE 110.

The general principle of selecting the UL beam for PRACH transmission illustrated by FIG. 9 is that the UE 110 selects a UL beam based on where the DCI including the PDDCH order was received, e.g., TRP 410 or TRP 420. Thus, the example of FIG. 9 could also show the PDCCH order being received from the TRP 410 and the UE 110 would select the UL beam for the PRACH transmission based on receiving the DCI from the TRP 410.

According to other example embodiments the UE 110 uses the SSB identified by the SSB index value provided in the PDCCH order for UL Beam determination.

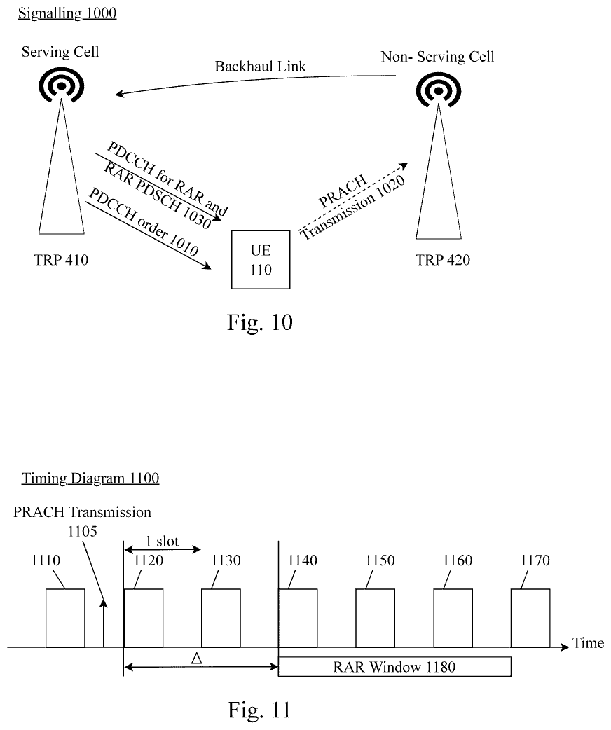

FIG. 10 shows a signaling diagram 1000 illustrating a second example of UL beam determination for PDCCH-Ordered PRACH transmissions according to various example embodiments. The signaling diagram 1000 illustrates the example described directly above. As will be described in greater detail below, in FIG. 10 the TRP 410 transmitting the PDCCH order is not the TRP (e.g., TRP 420) to which the PRACH is directed.

In 1010, the PDCCH order is transmitted to the UE 110 from the serving cell TRP 410. The PDCCH order includes an SSB identified by the SSB index value. In this example, it may be considered that the SSB index value included in the PDCCH order is the SSB index value of the non-serving cell TRP 420. While not shown in FIG. 10, the UE 110 will be receiving and measuring the SSB from the non-serving cell TRP 420. Thus, when the SSB index value corresponding to the non-serving cell TRP 420 is received in the PDCCH order, the UE 110 may determine the UL beam for the PRACH transmission from the information derived from the SSB received from the non-serving cell TRP 420. Thus, in 1020, the UE 110 transmits a PRACH to the non-serving cell TRP 420 and in 1030 the serving cell TRP 410 transmits a PDCCH for RAR and a RAR PDSCH to the UE 110.

According to further example embodiments the UE 110 may use a ‘cell indictor’ field that is included in the PDCCH order DCI for UL beam determination. In one example, the cell indictor field may be added into the PDCCH order DCI as a 1-bit field that indicates whether the PDCCH order trigged CFRA is for the serving cell or the non-serving cell. For example, a value of ‘0’ indicates the serving cell, while a value of ‘1’ indicates the non-serving cell.

In a second example, the cell indictor field may be added into the PDCCH order DCI as a 3-bit field that indicates whether the PDCCH order trigged CFRA is for the serving cell or the non-serving cell. For the non-serving cell, the value of the cell indicator field indicates the associated ‘additional PCI index’ that is preconfigured by RRC signaling for each non-serving cell/TRP. A value of ‘k’, 0<k<8 (e.g., 3 bits allows values of 0-7) is the corresponding additional PCI index for the non-serving cell/TRP. The additional PCI index was described above. A value of ‘0’ indicates the serving cell.

In these example embodiments, if a value of ‘0’ is provided in the PDCCH order DCI in either of the first or second examples, the UE 110 may select the UL beam for RACH using the operations described in relation to FIG. 9, e.g., where the UE 110 detected the PDCCH is used to select the UL beam. Otherwise, the UE 110 may select the UL beam for RACH using the operations described in relation to FIG. 10, e.g., based on the SSB value indicated in the PDCCH order.

According to still further example embodiments the UE 110 may use either the operations described in relation to FIG. 9 or FIG. 10 for UL beam determination. The selection of these alternative operations may be explicitly configured by RRC signaling.

In some of the example embodiments, the PRACH transmissions (e.g., PRACH transmission 920) may be transmitted with a single instance without repetition. These example embodiments may be more advantageous with respect to handover scenarios. However, the example embodiments of transmitting without repetition are not limited to handover scenarios.

According to some example embodiments, the operations related to UL beam determination for PRACH transmissions may also be applied for DL Transmission Configuration Indicator (TCI) state determination to monitor PDCCH for the corresponding Msg2 reception. As described in the examples above with reference to FIGS. 9 and 10, there may be some scenarios where the RAR is transmitted by the serving cell TRP 410 and other scenarios where the RAR is transmitted by the non-serving cell TRP 420.

For example, transmitting RAR using the non-serving cell TRP 420 as shown in FIG. 10, may result in some DL disruptions for a variety of reasons. Thus, in some example embodiments, regardless of the TRP that transmits the PDCCH order, the RAR is always transmitted from the serving cell TRP 410 to avoid interruption for DL reception. If this rule was in place for the operations of FIG. 9, the only change would be that the PDCCH for RAR and RAR PDSCH transmission 930 would be performed by the serving cell TRP 410.

In other example embodiments, the RAR transmissions may follow the same rule as the PRACH transmission as described with reference to FIG. 10, e.g., the RAR is based on the SSB index that is included in the PDCCH order.

As described above, the example embodiments are also related to approaches for PDCCH monitoring for RAR reception depending on whether the associated non-serving cell is an active additional PCI that has at least one DL TCI state activated by the TCI activation MAC-CE (this may be referred to as an “active non-serving cell”). The UE 110 may not transmit any UL signal to an inactive non-serving cell. However, the PDCCH order CFRA may still be useful such that the TA value can be obtained by the network even before the PCI is activated to reduce latency.

There may be multiple cases directed to these example embodiments. In a first case, if the PDCCH order triggered a PRACH transmission towards an active non-serving cell and the associated RAR is received from the serving cell, including both PDCCH and PDSCH such as shown with respect to FIG. 10. The TA value indicated by the received RAR is applied for the associated TAG-ID immediately. In some designs, an offset value Δ (e.g., in units of symbols) may be configured by SIB or dedicated RRC signaling to account for the RAR forwarding latency from the target non-serving cell to the serving cell.

Correspondingly, the RAR window starts at the first symbol of the earliest CORESET the UE is configured to receive PDCCH for Type1-PDCCH CSS set that is at least N=1+Δ symbols, after the last symbol of the PRACH occasion corresponding to the PRACH. In the scenario of carrier aggregation (CA), the RAR is received from the Special Cell (SpCell) where Type-1 CSS is configured for serving cells.

FIG. 11 shows an example timing diagram 1100 illustrating an example RAR window according to various example embodiments. The timing diagram 1100 is illustrating the example of the first case described above. In FIG. 11, it may be considered that there are multiple Type-1 CSS monitoring occasions 1110-1170 illustrated on the timeline. It may be considered that each consecutive monitoring occasion 1110-1170 is separated by one slot as shown between monitoring occasions 1120 and 1130. The use of Type-1 CSS monitoring occasions is only example and any other monitoring occasions that are configured to include RAR transmissions may be represented by the monitoring occasions 1110-1170.

At 1105, the UE 110 transmits a PRACH transmission. In legacy systems, the UE 110 would begin monitoring for RAR at the start of the slot that includes the monitoring occasion 1120.

However, as described above, there may be latency due to RAR forwarding latency from the target non-serving cell to the serving cell, e.g., over the backhaul link. As described above, this latency (Δ) may be signaled to the UE 110 using a SIB or dedicated RRC signaling. In this example, it may be considered that Δ=28 symbols (e.g., 2 slots). Thus, instead of beginning to monitor at the start of the slot that includes the monitoring occasion 1120, the UE 110 will apply a delay of Δ=28 symbols and begin the RAR monitoring window 1180 at the start of the slot including the monitoring occasion 1140. The length of the RAR monitoring window 1180 may be configured to have any length and the length shown in FIG. 11 is only example.

In a second case, if the PDCCH order triggered PRACH transmission is towards an inactive non-serving cell, there may be different options that may be considered for monitoring for the RAR message. In a first option, the RAR is not expected for the UE that transmits the CFRA PRACH. In a second option, the RAR is received in the same manner as described above for the first case. However, the TA value provided by the RAR is stored at the UE and is not applied until one of the following conditions are met. A first condition may be that at least one TCI state associated with the inactive non-serving cell is activated by MAC-CE signaling through linking with a codepoint of TCI field of DCI format. A second condition may be that the TAG-ID associated with the TA value is provided in a L1/L2 Triggered Mobility (LTM) MAC-CE signaling. When the second condition is the triggering condition for applying the TA value, an application time for the TA value may be defined relative to the last symbol of the corresponding MAC-CE.

The example embodiments are also related to a DL reference timing for applying a UL TA value. As described above, each TAG-ID may be associated with a CORESET Pool Index value ‘0’ or ‘1’ on a reference component carrier (CC). The DL reference timing for applying a UL TA value of a TAG-ID may be determined as follows. The DL reference timing for the TAG-ID associated with a CORESET Pool Index value ‘i’ (i=0,1) is the first detected path (in time) in the reference CC based on the DL RS of the active TCI state associated with the same CORESET Pool Index value ‘i’(i=0,1).

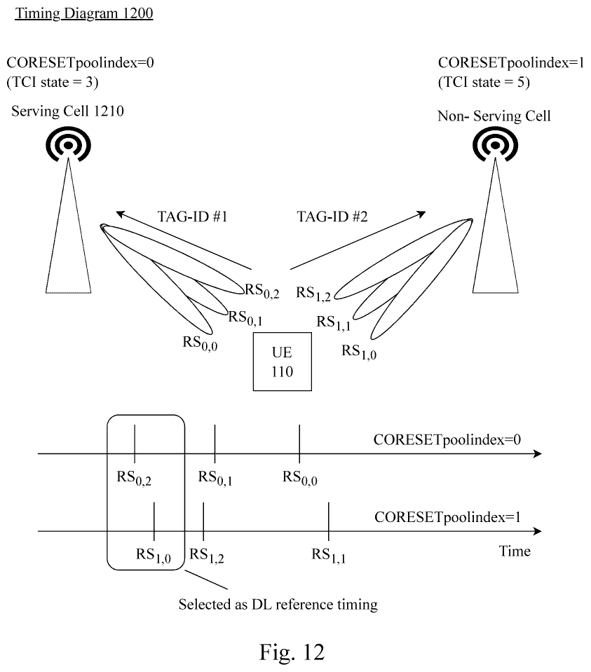

FIG. 12 provides an example timing diagram 1200 for determining the DL reference timing based on the DL-RSs associated with the different CORESET Pool Index value for a first TRP 1210 and a second TRP 1220 according to various example embodiments. In this example, it may be considered that each TRP is activated with three DL TCI states associated with three different reference signals (RSs), e.g., the TRP 1210 has CORESET Pool Index=0 and DL RSs of Active TCI states RS_{0,0}, RS_{0,1}, RS_{0,2}; and the TRP 1220 has CORESET Pool Index=1 and DL RSS of Active TCI states: RS_{1,0}, RS_{1,1}, RS_{1,2}.

The first detected DL RS paths in time are RS_{0,2} for the TRP 1210 and RS_{1,0} for the TRP 1220. In this example, the RS_{0,2} and RS_{1,0} are selected for TRP 1210 with CORESET Pool Index=0 and TRP 1220 with CORESET Pool Index=1 to derive the DL reference timing to apply the TA for UL transmissions.

### Examples

In a first example, a performed by a user equipment (UE) communicating with a first transmission and reception point (TRP) and a second TRP of a base station, comprising receiving Downlink Control Information (DCI) on a Physical Downlink Control Channel (PDCCH) with a PDCCH order that initiates a Contention Free Random Access (CFRA) procedure comprising a Physical Random Access Channel (PRACH) transmission, wherein the DCI comprises an identification of the first TRP or second TRP to which the PRACH transmission is to be directed and transmitting the PRACH transmission to the first TRP or second TRP based on at least in part the DCI.

In a second example, the method of the first example, wherein the identification comprises a 3-bit target cell index field in the DCI, wherein a value of the 3-bit target cell index field identifies the first TRP or second TRP.

In a third example, the method of the second example, wherein the DCI comprises a fallback DCI format 1_0.

In a fourth example, the method of the second example, wherein the second TRP is a non-serving cell and the value of the 3-bit target cell index field corresponding to the second TRP is received by the UE via Radio Resource Control (RRC) signaling prior to receiving the DCI.

In a fifth example, the method of the first example, wherein the DCI further comprises a 3-bit timing advance group identification (TAG-ID) field, wherein a value of the 3-bit TAG-ID field identifies the TAG-ID corresponding to the first TRP or second TRP.

In a sixth example, the method of the first example, further comprising receiving a Random Access Response (RAR) Medium Access Control (MAC) Protocol Data Unit (PDU) comprising information corresponding to a timing advance group identification (TAG-ID) corresponding to the first or second TRP.

In a seventh example, the method of the sixth example, wherein determining the TAG-ID from the information comprises receiving, via RRC signaling, a value of a coresetPoolIndex for each TAG-ID comprising a TAG-ID candidate pool, wherein the TAG-ID is a member of the TAG-ID candidate pool, determining a Physical Uplink Shared Channel (PUSCH) is scheduled using a dynamic grant or is activated by a second DCI that is received on a CORESET having a first coresetPoolIndex value and transmitting the PUSCH based on the TA value of the TAG-ID corresponding to the first CORESETpoolIndex value.

In an eighth example, the method of the sixth example, wherein determining the TAG-ID from the information comprises determining a transmission is one of a configured grant PUSCH transmission, a sounding reference signal (SRS) transmission or a PUCCH transmission and receiving a Radio Resource Control (RRC) message indicating the TAG-ID of the first or second TRP for one of the configured grant PUSCH transmission, the SRS transmission or the PUCCH transmission.

In a ninth example, the method of the first example, wherein CFRA PRACH resources associated with a Synchronization Signal Block (SSB) are divided into a first preamble subgroup and a second preamble subgroup, wherein each subgroup corresponds to a timing advance group identification (TAG-ID) corresponding to the first or second TRP, the method further comprising performing a Random Access Channel (RACH) procedure to determine a preamble that belongs to the first preamble subgroup or the second preamble subgroup, wherein a timing advance (TA) obtained via the RACH procedure corresponds to a TAG-ID for the first or second TRP.

In a tenth example, the method of the ninth example, wherein the first preamble subgroup has a first identification (ID) that has a value lower than a value of a second ID of the second preamble subgroup, wherein the first preamble subgroup is associated with a first TAG-ID having a value lower than that of a second TAG-ID.

In an eleventh example, the method of the first example, wherein Synchronization Signal Blocks (SSBs) are divided into a first subgroup and a second subgroup by system information block (SIB) or dedicated Radio Resource Control (RRC) signal, wherein each subgroup corresponds to a timing advance group identification (TAG-ID) corresponding to the first or second TRP, the method further comprising performing a Random Access Channel (RACH) procedure on an SSB indicated by the PDCCH order to determine the indicated SSB belongs to the first subgroup or the second subgroup, wherein a timing advance (TA) obtained via the RACH procedure corresponds to a TAG-ID for the first TRP when the indicated SSB belongs to the first subgroup or the second TRP when the indicated SSB belongs to the second subgroup.

In a twelfth example, the method of the first example, further comprising determining an uplink (UL) beam on which to transmit the PRACH that is indicated by the PDCCH order.

In a thirteenth example, the method of the twelfth example, wherein the determining the UL beam comprises determining a reference signal (RS) configured with Quasi Co-Location (QCL) Type-D for the PDCCH comprising the PDCCH order, wherein the RS corresponds to a beam of the first or second TRP.

In a fourteenth example, the method of the twelfth example, wherein the determining the UL beam comprises determining an SSB identified by an SSB index value provided in the PDCCH order, wherein the SSB corresponds to a beam of the first or second TRP.

In a fifteenth example, the method of the twelfth example, wherein the determining the UL beam comprises determining a value of a cell indictor field of the PDCCH order, wherein the value corresponds to the first or second TRP.

In a sixteenth example, the method of the fifteenth example, wherein the cell indicator field comprises 1-bit or 3-bits, where a value of 0 in the cell indicator field indicates the first TRP and a non-zero value in the cell indicator field indicates the second TRP, wherein the first TRP is a serving cell and the second TRP is a non-serving cell.

In a seventeenth example, the method of the sixteenth example, wherein the non-zero value of the 3-bit cell indicator field corresponding to the second TRP is received by the UE via Radio Resource Control (RRC) signaling prior to receiving the DCI.

In an eighteenth example, the method of the sixteenth example, wherein, when the value is 0, the determining the UL beam comprises determining a reference signal (RS) configured with Quasi Co-Location (QCL) Type-D for the PDCCH comprising the PDCCH order, wherein the RS corresponds to a beam of the first TRP.

In a nineteenth example, the method of the sixteenth example, wherein, when the value is non-zero, the determining the UL beam comprises determining an SSB identified by an SSB index value provided in the PDCCH order, wherein the SSB corresponds to a beam of the second TRP.

In a twentieth example, the method of the twelfth example, wherein the determining the UL beam comprises one of determining a reference signal (RS) configured with Quasi Co-Location (QCL) Type-D for the PDCCH comprising the PDCCH order, wherein the RS corresponds to a beam of the first or second TRP or determining an SSB identified by an SSB index value provided in the PDCCH order, wherein the SSB corresponds to a beam of the first or second TRP, wherein the one of the determining performed by the UE is configured by RRC signaling.

In a twenty first example, the method of the first example, wherein the PRACH transmission is transmitted without repetition.

In a twenty second example, the method of the first example, wherein the PRACH transmission is transmitted to the second TRP that is a non-serving cell having at least one downlink (DL) Transmission Configuration Indicator (TCI) state activated, the method further comprising monitoring for a Random Access Response (RAR) corresponding to the PRACH transmission in monitoring occasions associated with the CFRA, receiving the RAR comprising a timing advance (TA) value and applying the TA value for communications with the second TRP.

In a twenty third example, the method of the twenty second example, further comprising receiving a latency value indicating a latency for RAR forwarding between the first TRP and the second TRP and determining a starting time to begin monitoring scheduling DCI for the RAR based on at least the latency value.

In a twenty fourth example, the method of the twenty third example, wherein the determining the time comprises determining a first time when the PRACH transmission is transmitted, determining a second time when a first slot comprising a monitoring occasions starts, determining the starting time to begin monitoring scheduling DCI for the RAR by adding a third time associated with the latency value to the second time.

In a twenty fifth example, the method of the first example, wherein the PRACH transmission is transmitted to the second TRP that is a non-serving cell having no downlink (DL) Transmission Configuration Indicator (TCI) states activated.

In a twenty sixth example, the method of the twenty fifth example, wherein the UE omits monitoring for a Random Access Response (RAR) corresponding to the PRACH transmission.

In a twenty seventh example, the method of the twenty fifth example, further comprising monitoring for a Random Access Response (RAR) corresponding to the PRACH transmission in monitoring occasions associated with the CFRA, receiving the RAR comprising a timing advance (TA) value and storing the TA value at the UE.

In a twenty eighth example, the method of the twenty seventh example, further comprising applying the TA value for communications with the second TRP when at least one DL TCI state associated with the second TRP is activated.

In a twenty ninth example, the method of the twenty seventh example, further comprising applying the TA value for communications with the second TRP when a TAG-ID associated with the TA value of the second TRP is provided in a L1/L2 Triggered Mobility (LTM) MAC-CE signaling.

In a thirtieth example, the method of the first example, further comprising receiving a Random Access Response (RAR) comprising a timing advance (TA) value for UL transmissions with the TRP associated with a coresetPoolIndex value ‘0’ or second TRP associated with a coresetPoolIndex value ‘1’ and determining a DL reference timing for the UL transmission directed to the first TRP or the second TRP by applying the corresponding UL TA value.

In a thirty first example, the method of the thirtieth example, wherein determining the DL reference timing for the first TRP or the second TRP comprises for a TAG-ID associated with a coresetPoolIndex value ‘i’, i=0,1, determining a first detected path in time based on a DL RS of an active TCI state associated with the corresponding coresetPoolIndex value ‘i’.

In a thirty second example, a processor configured to perform any of the methods of the first through thirty first examples.

In a fortieth example, a user equipment comprising a transceiver configured to communicate with a base station and a processor communicatively coupled to the transceiver and configured to perform any of the methods of the first through thirty first examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A method, comprising:
receiving Downlink Control Information (DCI) on a Physical Downlink Control Channel (PDCCH) with a PDCCH order that initiates a Contention Free Random Access (CFRA) procedure comprising a Physical Random Access Channel (PRACH) transmission, wherein the DCI comprises an identification of a first transmission and reception point (TRP) or a second TRP to which the PRACH transmission is to be directed; and
configuring the PRACH transmission to the first TRP or second TRP based on at least in part the DCI.

2. The method of claim 1, wherein the identification comprises a 3-bit target cell index field in the DCI, wherein a value of the 3-bit target cell index field identifies the first TRP or the second TRP.

3. The method of claim 2, wherein the DCI comprises a fallback DCI format 1_0.

4. The method of claim 1, further comprising:
receiving a Random Access Response (RAR) Medium Access Control (MAC) Protocol Data Unit (PDU) comprising information corresponding to a timing advance group identification (TAG-ID) corresponding to the first or second TRP.

5. The method of claim 4, wherein determining the TAG-ID from the information comprises:
receiving, via RRC signaling, a value of a coresetPoolIndex for each TAG-ID comprising a TAG-ID candidate pool, wherein the TAG-ID is a member of the TAG-ID candidate pool;
determining a Physical Uplink Shared Channel (PUSCH) is scheduled using a dynamic grant or is activated by a second DCI that is received on a CORESET having a first coresetPoolIndex value; and
configuring the PUSCH based on a timing advance (TA) value of the TAG-ID corresponding to the first CORESETpoolIndex value.

6. The method of claim 4, wherein determining the TAG-ID from the information comprises:
determining a transmission is one of a configured grant PUSCH transmission, a sounding reference signal (SRS) transmission or a PUCCH transmission; and
receiving a Radio Resource Control (RRC) message indicating the TAG-ID of the first or second TRP for one of the configured grant PUSCH transmission, the SRS transmission or the PUCCH transmission.

7. The method of claim 1, further comprising:
determining an uplink (UL) beam on which to transmit the PRACH that is indicated by the PDCCH order.

8. The method of claim 7, wherein the determining the UL beam comprises:
determining an SSB identified by an SSB index value provided in the PDCCH order, wherein the SSB corresponds to a beam of the first or second TRP.

9. The method of claim 1, further comprising:
receiving a Random Access Response (RAR) comprising a timing advance (TA) value for UL transmissions with the TRP associated with a coresetPoolIndex value ‘0’ or the TRP associated with a coresetPoolIndex value ‘1’ ;
determining a DL reference timing for the UL transmission directed to the first TRP or the second TRP by applying the corresponding TA value for UL transmissions.

10. The method of claim 9, wherein determining the DL reference timing for the first TRP or the second TRP comprises:
for a TAG-ID associated with a coresetPoolIndex value ‘i’, i=0,1, determining a first detected path in time based on a DL RS of an active TCI state associated with the corresponding coresetPoolIndex value ‘i’.

11. An apparatus comprising processing circuitry configured to:
receive Downlink Control Information (DCI) on a Physical Downlink Control Channel (PDCCH) with a PDCCH order that initiates a Contention Free Random Access (CFRA) procedure comprising a Physical Random Access Channel (PRACH) transmission, wherein the DCI comprises an identification of a first transmission and reception point (TRP) or a second TRP to which the PRACH transmission is to be directed; and
configure transceiver circuitry to transmit the PRACH transmission to the first TRP or second TRP based on at least in part the DCI.

12. The apparatus of claim 11, wherein the identification comprises a 3-bit target cell index field in the DCI, wherein a value of the 3-bit target cell index field identifies the first TRP or the second TRP.

13. The apparatus of claim 12, wherein the DCI comprises a fallback DCI format 1_0.

14. The apparatus of claim 11, wherein the processing circuitry is further configured to:
receive a Random Access Response (RAR) Medium Access Control (MAC) Protocol Data Unit (PDU) comprising information corresponding to a timing advance group identification (TAG-ID) corresponding to the first or second TRP.

15. The apparatus of claim 14, wherein the processing circuitry determines the TAG-ID from the information by being configured to:
receive, via RRC signaling, a value of a coresetPoolIndex for each TAG-ID comprising a TAG-ID candidate pool, wherein the TAG-ID is a member of the TAG-ID candidate pool;
determine a Physical Uplink Shared Channel (PUSCH) is scheduled using a dynamic grant or is activated by a second DCI that is received on a CORESET having a first coresetPoolIndex value; and
configure the PUSCH based on a timing advance (TA) value of the TAG-ID corresponding to the first CORESETpoolIndex value.

16. The apparatus of claim 14, wherein the processing circuitry determines the TAG-ID from the information by being configured to:
determine a transmission is one of a configured grant PUSCH transmission, a sounding reference signal (SRS) transmission or a PUCCH transmission; and
receive a Radio Resource Control (RRC) message indicating the TAG-ID of the first or second TRP for one of the configured grant PUSCH transmission, the SRS transmission or the PUCCH transmission.

17. The apparatus of claim 11, wherein the processing circuitry is further configured to:
determine an uplink (UL) beam on which to transmit the PRACH that is indicated by the PDCCH order.

18. The apparatus of claim 17, wherein the processing circuitry determines the UL beam by being configured to:
determine an SSB identified by an SSB index value provided in the PDCCH order, wherein the SSB corresponds to a beam of the first or second TRP.

19. The apparatus of claim 11, wherein the processing circuitry is further configured to:
receive a Random Access Response (RAR) comprising a timing advance (TA) value for UL transmissions with the TRP associated with a coresetPoolIndex value ‘0’ or the TRP associated with a coresetPoolIndex value ‘1’ ;
determine a DL reference timing for the UL transmission directed to the first TRP or the second TRP by applying the corresponding TA value for UL transmissions.

20. The apparatus of claim 19, wherein the processing circuitry determines the DL reference timing for the first TRP or the second TRP comprises by being configured to:
for a TAG-ID associated with a coresetPoolIndex value ‘i’, i=0,1, determine a first detected path in time based on a DL RS of an active TCI state associated with the corresponding coresetPoolIndex value ‘i’.
